(19) United States
(12) Patent Application Publication
(10) Pub. No.: US 2015/0105913 A1
(43) Pub. Date: Apr. 16, 2015

(54) Information Interface and Drive System Having the Same

(71) Applicant: SICK STEGMANN GmbH, Donaueschingen (DE)

(72) Inventor: Bernd APPEL, Donaueschingen (DE)

(21) Appl. No.: 14/487,124

(22) Filed: Sep. 16, 2014

(30) Foreign Application Priority Data
Oct. 15, 2013 (EP) 13188703.6

(51) Int. Cl. G05B 15/02

(52) U.S. Cl. CPC G05B 15/02
USPC 700/275

(57) ABSTRACT

An information interface is provided for the provision of communication between a drive sensor arrangement, which drives a machine, and a control, which controls or regulates the drive sensor arrangement. The information interface includes an input/output unit for the reception of first information signals of at least one data detection unit of the drive sensor arrangement and for the output of a second information signal by means of a data transfer telegram to the control. The information interface also includes an information processing unit for processing the first information signals to the second information signal. The first information signals are composed of very different types of data formats and the information processing unit is provided for the transformation of the very different types of first information signals into a predefined unified data format and for the generation of the second information signal.

The present invention relates to an information interface for the provision of a communication between a drive sensor arrangement, which drives a machine, such as a punch press, a belt conveyor or the like, and a control which controls and/or regulates the drive sensor arrangement.

A common drive sensor arrangement is typically composed of a drive, which is composed of a motor and possibly of a transmission, a sensor, which in particular is a position encoder, and a control. The drive is installed in an automated plant and moves an axis of the plant in a rotary or linear manner. The sensor is mechanically directly connected to the drive, such that it detects information with respect to the moved axis, such as e.g. position, speed, acceleration or the like and communicates this information to the control. The control calculates control variables and/or process variables which serve for the control and/or the regulation of the drive from the information.

The exchange of the data between the components is carried out by data lines and also by so-called bus systems.

Modern drive sensor arrangements, in the following also referred to as systems, require an increase of information detected and information exchange in order to improve the performance and the availability of the overall arrangement and/or of the overall system.

This leads thereto that the existing systems are partly designed very heterogeneously and complex. This means that the systems have a large demand in cabling and a complicated configuration.

From the DE 10 2005 016 855 A1 a system is known which is composed of a motor, sensors, a control and an interface module. Hereby the sensors detect different physical parameters of the system and forward these to the interface module. The interface module processes the sensor signals to evaluation signals and transmits the evaluation signals to the control via a bus line.

It is an object of the present invention to improve an information interface for the provision of a communication between a drive sensor arrangement and a control in such a way that a central and simple communication is enabled.

The object is satisfied in accordance with the invention by means of an information interface for the provision of a communication between a drive sensor arrangement which drives the machine; and a control which controls or regulates the drive sensor arrangement; the information interface comprising an input/output unit for the reception of first information signals from at least one data detection unit of the drive sensor arrangement and for the transmission of a second information signal by means of a data transfer telegram to the control; and an information processing unit for processing the first information signals to the second information signal, wherein the first information signals are composed of very different types of data formats and the information processing unit is provided for the transformation of the different types of first information signals into a predefined unified data format and for the generation of the second information signal, wherein the second information signal is only composed of the predefined unified data format and the different types of first information signals vary in their data formats by means of different data kinds, data types and/or data protocols; and wherein the data kind includes analog or digital information, the data type represents a typing used by the data detection unit and the data protocol represents predefined data exchange rules, wherein the typing is classified in ordinal, elemental, universal, abstract and/or proprietary syntax.

In accordance with a preferred embodiment the different types of first information signals are signals from external sensors, encoders and/or resolvers. Thereby the advantage results that the information interface in accordance with the invention can be extended and/or configured in a flexible manner such that various sensors and their specific data format can be communicated to the control in a simple manner. For this purpose, the information interface makes available various connection possibilities, signal detection, signal processing, signal transformation and signal forwarding.

Advantageously, the input/output unit is provided for the reception of a control signal from the control by means of the data transfer telegram and for the output of at least one control input to at least one actuator, in particular a brake, a cooling, a vibration compensator and/or the like of the drive sensor arrangement.

In accordance with a further preferred embodiment the information processing unit transforms the first information signals in real time and the second information signal can be transmitted in real time.

In accordance with a further preferred embodiment the information processing unit is provided for the buffering of the first information signals and of the second information signal. Thereby a monitoring and analysis of the system is enabled, wherein a diagnosis and in this way associated possible error corrections of the system can be strongly simplified.

In accordance with a further preferred embodiment the first information signals represent a position, a speed, an acceleration, a temperature, a vibration, a mechanical state and the like of the drive sensor arrangement and/or of their actuators.

In accordance with a further embodiment a wireless data transmission is provided.

Furthermore, a drive system is provided which has a drive sensor arrangement which drives a machine, a control which controls or regulates the drive sensor arrangement, and an information interface in accordance with the invention.

In the following, the invention will be described in detail by means of embodiments with reference to the drawing. In the drawing there is shown:

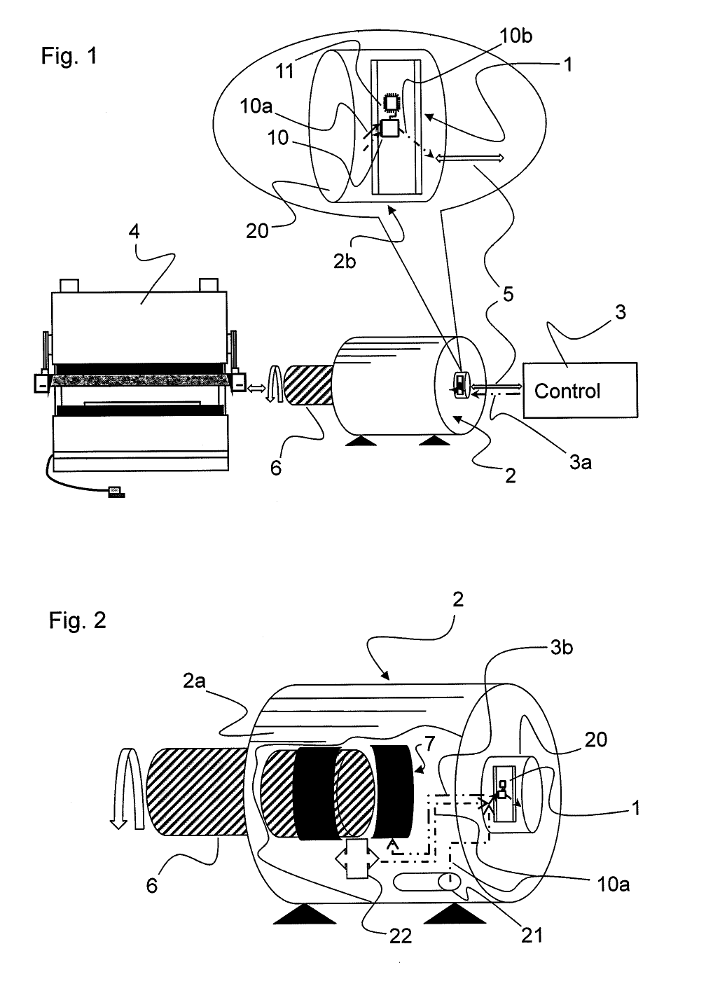

FIG. 1 a schematic illustration of an automated plant having an information interface in accordance with the invention; and

FIG. 2 a schematic representation of a drive sensor arrangement in accordance with the invention having additional actuators.

In the FIG. 1, an automated plant is schematically illustrated in which a machine 4, e.g. a punch, is driven by means of a drive sensor arrangement 2. The drive sensor arrangement 2 is composed of a drive 2a having a shaft 6 which is connected to the machine 4 and drives this, a data detection unit 2b which detects the information relating to the drive 2a and which is mechanically connected to the shaft 6; and a control 3 which controls and/or regulates the drive 2a.

In accordance with the embodiment the data detection unit 2b is composed of a position encoder 20 which detects the information with respect to the position, the speed, the acceleration or the like of the shaft 6 and transmits it to the control 3. The data transmission takes place via a data transfer telegram 5 in such a way that control signals 3a from the control 3 can be transmitted to the drive 2a in order to control and/or to regulate the drive 2a during operation.

An information interface 1 in accordance with the invention is provided in order to provide a communication between the drive sensor arrangement 2 and the control 3.

Hereby the information interface 1 can be integrated in or at the drive 2a, in particular at its shaft 6, or can be integrated into the data detection unit 2b or can be provided at the same.

The information interface 1 has an input/output unit 10 which is configured for the reception of different types of data formats, in particular composed of different data formats, first information signals 10a of the data detection unit 2b and for the output of a second information signal 10b by means of the data transfer telegram 5 to the control. Hereby, a data message transferred between the data detection unit 2b and the control 3 is understood as a data transfer telegram in the sense of the invention, wherein the data message includes certain information with respect to the drive 2a, a predefined structure of the information, a predefined message structure and advantageously a command relating to a processing of the telegram.

Furthermore, the information interface 1 comprises an information processing unit 11 which is configured for the processing of the first information signals 10a to the second information signal 10b. The information processing unit 11 transforms the different types of first information signals 10a into a predefined unified data format and generates the second information signal 10b which is only composed of the predefined unified data format. The second information signal 10b having the predefined unified data format is integrated into the data transfer telegram 5 and is transmitted via the input/output unit 10 to the control 3.

Since the data detection unit 2b in the described embodiment can be composed of a position encoder 20 or also of different external sensors, encoders and/or resolvers, the information interface 1 in accordance with the invention enables a detection of the different types of information signals in a simple kind and manner and realizes a transmission of an information signal with a unified data format so that a further processing is correspondingly simplified in the control 3. This means that the detected first information signals 10a are signals of the external sensors, encoders and/or resolver which in particular are composed of completely different types of data formats and are transformed into the second information signal 10b composed of the predefined unified data format.

Hereby the different types of first information signals 10a vary in their data formats by means of different data kinds, data types and/or data protocols. In the sense of the invention the data kind, for example includes analog or digital information. The data type represents a typing used by the data detection unit 2b and the data protocol represents predefined data exchange rules. The typing is advantageously classified in ordinal, elementary, universal, abstract and/or proprietary syntax.

Thus, the information signals 10b can be detected, processed and transmitted as an information signal 10b composed of the predefined unified data format by means of the information interface 1 in accordance with the invention completely independently of the hardware and/or firmware of the data detection unit 2b used, in particular of the sensors used.

Hereby the control 3 processes the second information signal 10b in accordance with the received data transfer telegram and transmits a control signal 3a to the input/output unit 10 of the information interface 1 by means of the data transfer telegram, the information interface is in turn configured for the output of at least one control input 3b to at least one connected actuator, in particular a brake 7, a cooling, a vibration compensator and/or the like, of the drive sensor arrangement 2. Preferably the information processing unit 11 transforms the first information signals 10a in real time and the second information signal 10b is transmitted in real time.

Advantageously, the information processing unit 11 is configured for the buffering of the first information signals 10a and of the second information signal 10b. Thereby the control 3 can access the data during a diagnosis of the drive sensor arrangement 2.

In accordance with a preferred embodiment the drive 2a, as is shown in FIG. 2, has further sensors and actuators besides the position encoder 20. A temperature sensor 21 is provided in order to determine the temperature of the drive sensor arrangement 2. Furthermore, a brake sensor 22 is provided which detects a state of a brake 7 of the drive 2a.

The different types of information signals 10a arising due to the different hardware and firmware of the used sensors are transmitted to the information interface 1 in accordance with the invention, wherein the invention interface 1 receives the information signals 10a with their different types of data format and transforms these to the second information signal 10b having the unified data format.

Hereby, the data formats are different from one another by means of their different data kinds, data types and/or data protocols. Analog or digital information is understood as the data kind. The data type represents a typing used for the sensors. The data protocol represents predefined data exchange rules which to a certain degree are similar to the data exchange telegram 5.

The information interface 1 thus unifies the information signals 10a and processes the unified information signal 10b into the data exchange telegram 5 to the control 3.

The control 3 can control and/or regulate the drive 2a by means of the control signal 3a.

Hereby a state of the brakes 7 of the drive 2a can be monitored in accordance with the preferred embodiment in such a way that a warning can take place by the information interface for a given wear limit.

Furthermore, the information interface 1 can generate a control input 3b and can activate and/or deactivate the brake 7 by means of the control input 3b in such a way that the control of the brake 7 can partly be shifted and located into the information interface 1 from the control 3.

The complete data communication can also be carried out wirelessly to and/or from the information interface 1. Hereby the communication is configured bidirectionally, independent thereof whether it is a wired connection or a wireless connection.

### LIST OF REFERENCE NUMERALS

1 information interface

2 drive sensor arrangement

2a drive

2b data detection unit

3 control

3a control signal

3b control input

4 machine

5 data transfer telegram

6 shaft

7 brake

10 input/output unit

10a first information signals

10b second information signal

11 information processing unit

20 position sensor

21 temperature sensor

22 brake sensor

What is claimed is:

1. An information interface for the provision of a communication between a drive sensor arrangement which drives a machine and a control which controls or regulates the drive sensor arrangement, the information interface comprising an input/output unit for the reception of first information signals of at least one data detection unit of the drive sensor arrangement and for the transmission of a second information signal to the control by means of a data transfer telegram; and an information processing unit for the processing of the first information signals to the second information signal,
wherein
the first information signals are composed of very different types of data formats and the information processing unit is provided for the transformation of the different types of first information signals into a predefined common data format and for the generation of the second information signal, wherein the second information signal is only composed of the predefined unified data format and the different types of first information signals vary in their data formats, by means of different data kinds, data types and/or data protocols and wherein the data kind includes analog or digital information, the data type reproduces the typing used in the data detection unit and the data protocol represents predefined data exchange rules, wherein the typing is classified in ordinal, elementary, universal, abstract and/or proprietary syntax.

2. The information interface in accordance with claim 1, wherein the different types of first information signals are signals from external sensors, encoders and/or resolvers.

3. The information interface in accordance with claim 1, wherein the input/output unit is provided to receive a control signal from the control by means of the data transfer telegram and for the transmission of at least one control input to at least one actuator of the drive sensor arrangement.

4. The information interface in accordance with claim 3, wherein the actuator is one of a brake, a cooling, a vibration compensator and/or the like.

5. The information interface in accordance with claim 1, wherein the information processing unit transforms the first information signals in real time and the second information signal can be transmitted in real time.

6. The information interface in accordance with claim 1, wherein the information processing unit is provided for the buffering of the first information signals and of the second information signal.

7. The information interface in accordance with claim 1, wherein the first information signals reproduce a position, a speed, an acceleration, a temperature, a vibration, a mechanical state and/or the like of the drive sensor arrangement and/or of their actuators.

8. The information interface in accordance with claim 1, wherein a wireless data transfer is provided.

9. A drive system having a drive sensor arrangement which drives a machine, a control which controls or regulates the drive sensor arrangement and an information interface,
the information interface comprising an input/output unit for the reception of first information signals of at least one data detection unit of the drive sensor arrangement and for the transmission of a second information signal to the control by means of a data transfer telegram; and an information processing unit for the processing of the first information signals to the second information signal,
wherein the first information signals are composed of very different types of data formats and the information processing unit is provided for the transformation of the different types of first information signals into a predefined common data format and for the generation of the second information signal, wherein the second information signal is only composed of the predefined unified data format and the different types of first information signals vary in their data formats, by means of different data kinds, data types and/or data protocols and wherein the data kind includes analog or digital information, the data type reproduces the typing used in the data detection unit and the data protocol represents predefined data exchange rules, wherein the typing is classified in ordinal, elementary, universal, abstract and/or proprietary syntax.
